(19) United States
(12) Patent Application Publication
(10) Pub. No.: US 2004/0089006 A1
(43) Pub. Date: May 13, 2004

(54) Vehicle air conditioner

(76) Inventors: Toshifumi Kamiya, Takahama-city (JP); Shinji Aoki, Chiryu-city (JP)

Correspondence Address: HARNESS, DICKEY & PIERCE, P.L.C., P.O. BOX 828, BLOOMFIELD HILLS, MI, 48303, US

(21) Appl. No.: 10/700,927

(22) Filed: Nov. 4, 2003

(30) Foreign Application Priority Data
Nov. 5, 2002 (JP) 2002-321266

(51) Int. Cl. B60H 3/00; B61D 27/00; B60H 1/00; B60H 1/32

(52) U.S. Cl. 62/244; 165/202; 165/42

(57) ABSTRACT

In a vehicle air conditioner, air having passed through a heat exchanger of an air conditioner unit is introduced to a plurality of wall outlet portions formed on walls of a compartment and blown off into the compartment. The air conditioner unit includes a plurality of temperature control means for independently controlling at least one of volume and temperature of the air flowing into the compartment through the respective wall outlet portions.

### CROSS REFERENCE TO RELATED APPLICATION

This application is based on Japanese Patent Application No. 2002-321266 filed on Nov. 5, 2002, the disclosure of which is incorporated herein by reference.

### FIELD OF THE INVENTION

The present invention relates to a vehicle air conditioner that produces flows of air from an interior wall of a compartment of a vehicle.

### BACKGROUND OF THE INVENTION

A vehicle air conditioner is known that controls the operation of an air-conditioner unit in response to the operation of a thermo sensing auxiliary device so that a passenger compartment is air-conditioned at a predetermined thermal level preset by a temperature setting means. This kind of vehicle air conditioner is for example disclosed in a Japanese unexamined patent publication No. JP-A-6-234318.

In JP-A-6-234318, disclosed is a thermo sensing auxiliary device for controlling the surface temperature of plural positions of the compartment independently by using an electric heating device such as a flat heating element, heating wire, or a thermoelectric element which converts electric power to heat. However, in this air conditioner, its consumption power is large because of such electric heating device.

Incidentally, when closing the door of the vehicle, the air pressure in the compartment increases and this causes the air to flow back into a duct where the air pressure is low. This phenomenon is likely to cause the deposition of dust or particulate matter suspended in the air onto the outlet of the air-conditioner unit by slow degrees at a time of door opening/closing, thus resulting in some blur at or near the outlet of the air-conditioner unit.

### SUMMARY OF THE INVENTION

The present invention is made in view of the foregoing matter and it is an object of the present invention to provide a vehicle air conditioner that independently controls temperature and volume of air of plural walls of a compartment without using an electric heating device.

It is another object of the present invention to provide a vehicle air conditioner capable of independently restricting irradiation from plural walls of a compartment.

It is further another object of the present invention to provide a vehicle air conditioner capable of restricting air from flowing back into a duct from a compartment.

According to the present invention, an air conditioner for air-conditioning a compartment of a vehicle includes a heat exchanging unit, a plurality of wall outlet portions, and a plurality of air temperature control means. The heat exchanger unit performs heat exchange between air to be blown into the compartment and a fluid flowing inside of the heat exchanging unit. The air having passed through the heat exchanging unit is introduced into the compartment through the air outlet portions. The wall outlet portions are formed on walls of the compartment, so that the air exudes from the walls into the compartment. The plurality of air temperature control means is disposed such that at least one of temperature and volume of the air passing through the air outlet portions is controlled independently.

Accordingly, the conditions of the air of the plural portions of the compartment are independently controlled. By this, because the temperature of the walls is close to that of the skin temperature of a passenger, the effect of irradiation from the walls of the compartment is restricted.

Preferably, a reverse flow restricting means is provided proximate to the air outlet portion. Thus, the air in the compartment is restricted from flowing back into a duct. Accordingly, it is less likely that dusts will accumulate on the air outlets of the walls.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic cross-sectional view of a vehicle air conditioner unit according to the first embodiment of the present invention;

FIG. 2 is a schematic diagram for showing a control system of the air conditioner unit according to the first embodiment of the present invention;

FIG. 3 is a schematic view of a compartment for showing air outlet portions formed in the compartment according to the first embodiment of the present invention;

FIG. 4 is a schematic cross-sectional view of an interior wall of the compartment that provides a wall air outlet according to the first embodiment of the present invention;

FIG. 5 is a schematic view of the compartment for showing positions detected by an IR sensor according to the second embodiment of the present invention;

FIG. 6 is a schematic diagram for showing regions detected by the IR sensor according to the second embodiment of the present invention;

FIG. 7 is a flow chart of a control of the air conditioner according to the second embodiment of the present invention;

FIG. 8 is a cross-sectional view of an interior wall of the compartment having a check valve according to the third embodiment of the present invention;

FIG. 9 is a flow chart of a control of the air conditioner unit according to another embodiment of the present invention; and

FIG. 10 is a graph showing the relationship between a volume of airflow and an elapsed time for the control shown in FIG. 9.

### DETAILED DESCRIPTION OF EMBODIMENTS

Embodiments of the present invention will be described hereinafter with reference to the drawings.

[First Embodiment]

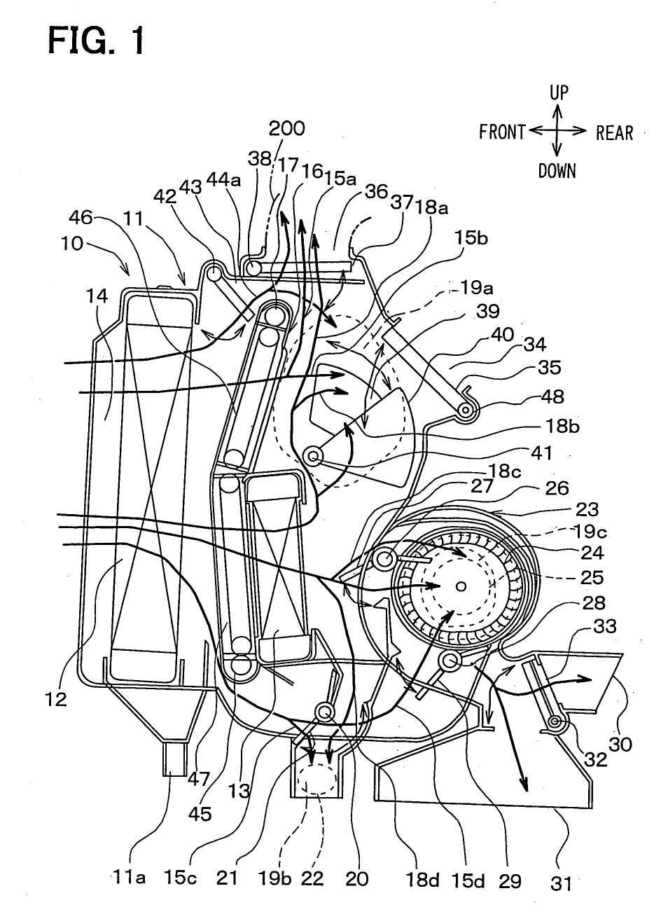

Referring to FIG. 1, an air conditioner unit 10 of a vehicle air conditioner has an air conditioner case 11. Although not illustrated, an inside of the case 11 is generally separated into a left part and a right part by a separation wall at its middle position. The air conditioner unit 10 has a symmetrical structure with respect to the separation wall in a vehicle right and left direction (lateral direction). Hereinafter, the description will be mainly made with an example of the left part of the air conditioner unit 10 shown in FIG. 1. In FIG. 1, a front and rear arrow and an up and down arrow denote the arrangement direction of the air conditioner unit 10 when mounted on a vehicle.

The vehicle air conditioner includes an air blower unit (not shown) and the air-conditioner unit 10. The air-conditioner unit 10 is arranged at a substantially middle position in the vehicle right and left direction in a space defined in an instrument panel of the vehicle. The blower unit is arranged to offset from the air-conditioner unit 10 on a passenger seat side.

The blower unit includes an inside/outside air switching box and a blower (main blower) such as a centrifugal motor-driven blower. The inside/outside air switching box switches air-intake modes between an inside air mode for sucking an inside air inside the compartment and an outside air mode for sucking an outside air outside the compartment. The main blower draws air through the inside/outside air switching box and blows it toward the air conditioner unit 10.

The air-conditioner unit 10 includes an evaporator 12 and a heater core 13 both housed in the case 11. The case 11 is a molded article made of resin such as polypropylene having some resiliency along with a superior strength. The case 11 is actually constructed of plural separate cases. The separate cases are connected into the single case 11 by a fastener means such as metal spring clips and screws.

The air-conditioner unit 10 is arranged in a way shown in FIG. 1, regarding the front and rear and the up and down directions of the vehicle. At a very front position of the case 11, an air intake chamber 14 is formed. The air intake chamber 14 receives the air from the blower unit.

The evaporator 12 is arranged behind the air intake chamber 14, that is, downstream of the air intake chamber 14 with respect to an air flow direction. The air in the air intake chamber 14 passes through the evaporator 12 and flows toward the rear side of the case 11. The evaporator 12 is thinner in its form in the vehicle front and rear direction. The evaporator 12 is arranged substantially in the vertical direction such that it intersects the left part and the right part of the case 11. The evaporator 12 is a cooling heat exchanger that absorbs heat from the air by latent heat of evaporation of a refrigerant (inside fluid) of the refrigeration cycle, to thereby cool the air. At the bottom of the case 11, a drain pipe 11a is provided for draining the condensed water generated on the evaporator 12.

The heater core 13 is arranged downstream of the evaporator 12, that is, on a rear side of the evaporator 12 at a predetermined interval. The heater core 13 is positioned in a lower portion of the case 11 and inclined to the rear side of the vehicle. Similar to the evaporator 12, the heater core 13 is arranged to intersect the left part and the right part of the case 11. The dimension (width) of the evaporator 12 and the heater core 13 in the vehicle right and left direction is approximately equal to the width of the case 11.

The heater core 13 is to heat the cooled air having passed through the evaporator 12. A high temperature fluid such as a coolant of an engine circulates in the inside of the heater core 13. The heater core 13 is a heating heat exchanger for performing heat exchange between the coolant and the air, to thereby heating the air.

A left film air mix door 16 is arranged between the heater core 13 and the evaporator 12 such that is capable of being reciprocated therebetween. The left film air mix door 16 is a film-type door. The left film air mix door 16 adjusts the volume of cooled air passing through cooled air passages 15a, 15b, which bypasses the heater core 13, and the volume of air to be passed through the heater core 13, to thereby control the temperature of air to be blown into a left region of the passenger compartment. The left film air mix door 16 provides a first temperature control means.

Specifically, a cooled air film 46 is reciprocated by a first left driving shaft 17 to change an opening area (communicable sectional area) of the cooled air film 46. The cooled air passages 15a, 15b passing through the left film air mix door 16 is adjusted by changing the opening area of the film 46. Similarly, a heated air film 47 is reciprocated by a second left driving shaft 45 to change an opening area (communicable sectional area) of the heated air film 47. The heated air passage 18a, 18b, 18c, 18d passing through the left film air mix door 16 to the heater core 13 is adjusted by changing the opening area (communicable sectional area) of the film 47.

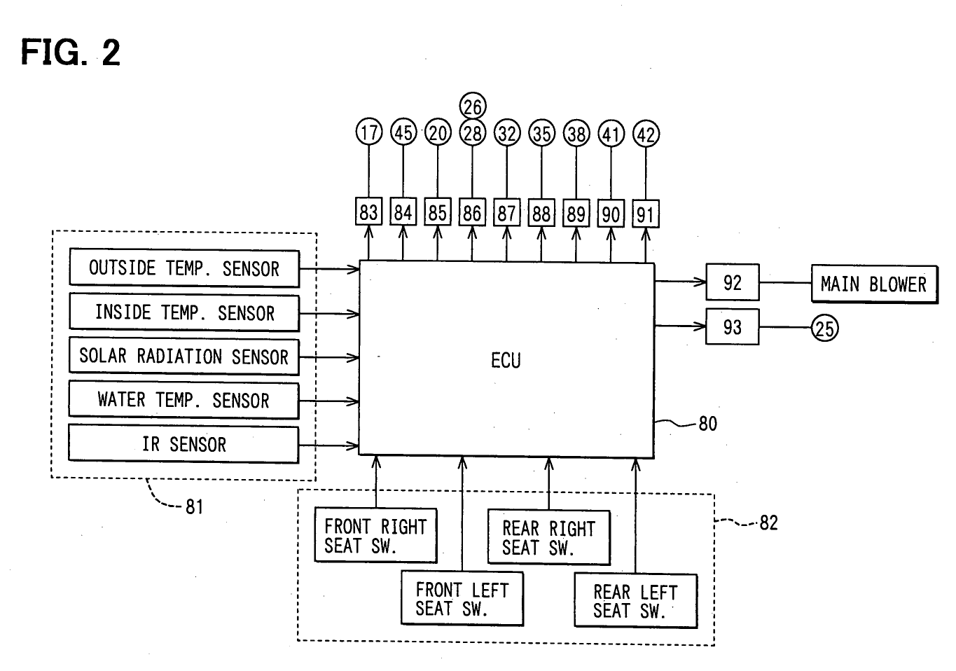

The first left driving shaft 17 and the second left driving shaft 45 are rotatably supported by the case 11. One end of the first left driving shaft 17 and one end of the second left driving shaft 45 project to the outside of the case 11, respectively. The driving shafts 17, 45 are respectively connected to left actuators 83, 84 through link systems (not shown), as shown in FIG. 2. The left actuators 83, 84 are served for independently controlling the opening/closing position, that is, opening rate, of the left film air mix door 16. Similarly, a right film air mix door (not shown), which has the same structure as the left film air mix door 16, is symmetrically provided on the right side of the separation wall in the case 11. The right film air mix door provides a second temperature control means.

The heated air passage 18a is formed such that the heated air flows from a rear position of the heater core 13 toward the above (top side of the case 11), on a side downstream of the heater core 13. The heated air passage 18a merges with the cooled air passages 15a, 15b at an air mixing area 19a that is above the heater core 13. Thus, the cooled air and the heated air are mixed at the air mixing area 19a.

A front left seat air mix door 21, which is integrally connected to a third left driving shaft 20, is rotatably supported on a left side wall of the case 11 under the heater core 13. The front left seat air mix door 21 has a substantially L-shape. Similarly, a front right seat air mix door (not shown), which has the same structure as the front left seat air mix door 21, is rotatably supported on a right side wall of the case 11.

The front left seat air mix door 21 and the front right seat air mix door adjust the ratio of the cooled air passing through the cooled air passage 15c to the heated air that has passed through the heater core 13 and flows through the heated air passage 18d, to thereby control the temperature of the air to be blown into the compartment. The front left seat air mix door 21 and the front right seat air mix door provide a third temperature control means and a fourth temperature control means, respectively.

The third left driving shaft 20 is rotatably supported by the case 11. One end of the passenger third driving shaft 20 projects to the outside of the case 11 and is connected to an actuator 85 through a link system (not shown), as shown in FIG. 2. Thus, the opening/closing position of the front left seat air mix door 21 is adjusted by the left actuator 85.

In the case 11, the heated air passage 18d is formed such that the heated air having passed through the heater core 13 flows downwardly on the rear side of the heater core 13. The heated air passage 18d merges with the cooled air passage 15c below the heater core 13, thereby mixing the heated air the cooled air at an air mixture area 19b.

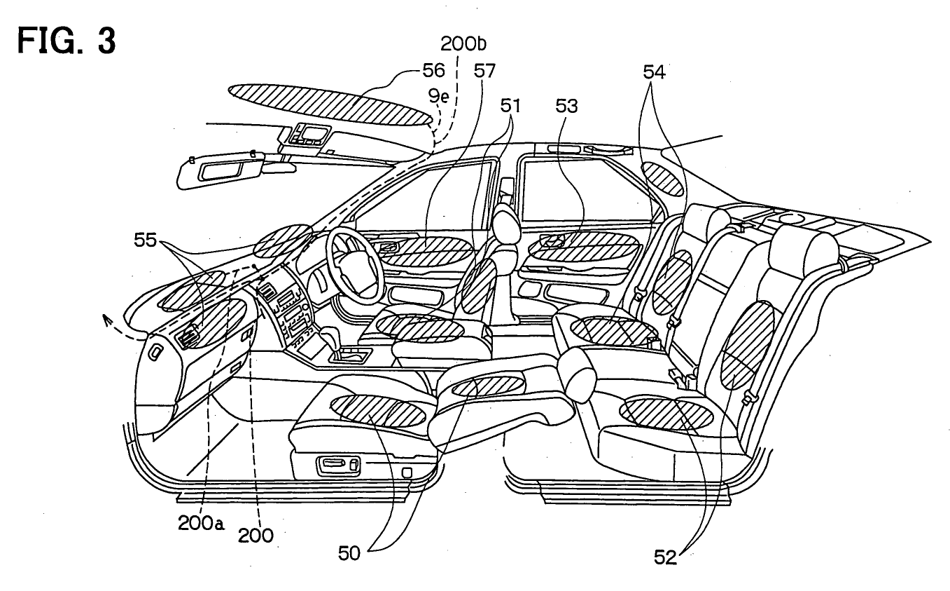

The air mixture area 19b is located proximate to a front left seat opening 22 formed at a lower side of the case 11. The front left seat opening 22 communicates with a front left seat outlet 50, which is shown in FIG. 3, for introducing the air mixed at the air mixture area 19b to the outlet 50. Similarly, a front right seat opening (not shown), which has the same structure as the front left seat opening 22, is symmetrically provided on the right side of the separation wall in the case 11.

A rear left seat auxiliary blower 23 is provided downstream of the heater core 13, that is, on the rear side of the heater core 13. The rear left seat auxiliary blower 23 is provided for sending the air toward the rear seat region, especially, a rear left region of the compartment. The rear left seat auxiliary blower 23 includes a rear left centrifugal fan 24, which is rotatably housed in a scroll case, and a blower motor 25 for driving the rear left centrifugal fan 24.

The blower motor 25 is controlled based on a blower terminal voltage that is applied through a blower driving circuit 93 (FIG. 2). By this, rotation of the fan 24, that is, a volume of air blown by the fan 24 is controlled. Similarly, a rear right seat auxiliary blower (not shown), which has the structure same as the rear left seat auxiliary blower 23, is symmetrically provided on the rear side of the separation wall in the case 11. The rear right auxiliary blower connects to a driving shaft of the blower motor 25 through a link system.

A rear left seat heated air mix door 27, which is integrally connected to a fourth left driving shaft 26, is rotatably supported on the left side wall of the case 11, at a position upstream of the rear left seat auxiliary blower 23, that is, on a front side of the rear left seat auxiliary blower 23. The rear left seat heated air mix door 27 has a substantially L-shaped cross-section. The rear left seat heated air mix door 27 is disposed to provide the heated air passage 18c through which the heated air flows toward the blower 23. Similarly, a rear right seat heated air mix door (not shown), which has the same structure as the rear left seat heated air mix door 27, is symmetrically provided on the right side of the separation wall in the case 11.

A rear left seat cooled air mix door 29, which is integrally connected to a fifth left driving shaft 28, is rotatably supported on the left side wall of the case 11, at a position upstream of the rear left seat auxiliary blower 23. The rear left seat cooled air mix door 29 is arranged to provide the cooled air passage 15d through which the cooled air flows toward the blower 23. The rear left seat cooled air mix door 29 has the shape similar to the rear left seat heated air mix door 27. Similarly, a rear right seat cooled air mix door (not shown), which has the same structure as the rear left seat cooled air mix door 29, is symmetrically provided on the right side of the separation wall in the case 11.

The fourth left driving shaft 26 and the fifth left driving shaft 28 are so constructed as to allow power transmission through a power transmission means such as a timing belt. The fourth left driving shaft 26 is rotatably supported in the case 11. One end of the fourth left driving shaft 26 projects to the outside of the case 11, and connects to a left actuator 86 (see FIG. 2) through a link system (not shown). The left actuator 86 interconnects the rear left seat heated air mix door 27 with the rear left seat cooled air mix door 29, thereby to control opening and closing of the air mix doors 27, 29. Similarly, a rear right seat heated air mix door and a rear right cooled air mix door (both not shown), which have the same structure as the air mix doors 27, 29, respectively, are provided symmetrically on the right side of the separation wall in the case 11.

The rear left seat heated air mix door 27 and the rear left seat cooled air mix door 29 adjust the volumes of the cooled air flowing through the cooled air passage 15d and the heated air flowing through the heated air passage 18c, thereby controlling the temperature of the air to be blown to the rear left region of the compartment. In a similar manner, the rear right seat heated air mix door and the rear right seat cooled air mix door (both not shown) control the temperature of the air to be blown into the rear right region of the passenger compartment. The air mix doors 27, 29 provide a fifth temperature control means. The rear right seat heated air mix door and the rear right seat cooled air mix door provides a sixth temperature control means.

As have been described above, the heated air passage 18c through which the heated air having passed through the heater core 13 flows toward the rear side of the case 11 is formed downstream of the heater core 13 in the case 11 (lower side of the case 11). The heated air passage 18c and the cooled air passage 15d merge with each other at an air mixture area 19c. The air mixture area 19c is located adjacent to an air intake port of the centrifugal fan 24 formed on a side of the fan 24 in the axial direction.

The case 11 forms a rear left door trim opening 30 and a rear left seat opening 31 at positions downstream of the rear left seat auxiliary blower 23. Similarly, the case 11 forms a rear right door trim opening and a rear right seat opening at positions downstream of the rear right seat auxiliary blower (not shown).

A rear left seat air-distributing door 33 is rotatably supported at a position upstream of the rear left door trim opening 30 and the rear left seat opening 31. The rear left seat air-distributing door 33 is integrally connected to a sixth left driving shaft 32. Similarly, a rear right seat air-distributing door (not shown), which has the same structure as the rear left seat air-distributing door 33, is provided at a position upstream of the rear right seat door trim opening and the rear right seat opening.

The sixth left driving shaft 32 is rotatably supported by the case 11. One end of the sixth left driving shaft 32 projects to the outside of the case 11 and is connected to an actuator 87 (FIG. 2) through a link system (not shown). Thus, the opening/closing position of the rear left seat air-distributing door 33 is controlled by the actuator 87.

The rear left seat door trim opening 30 communicates with a rear left door trim outlet (not shown) through a duct. The rear left seat opening 31 communicates with a rear left seat outlet 52, which is shown in FIG. 3, through a duct. Similarly, the rear right seat door trim opening communicates with a rear right door trim outlet 53 through a duct. The rear right seat opening communicates with a rear right seat outlet 54 through a duct.

The top wall of the case 11 includes an inclined wall at a position above the air mixture area 19a, that is, a rear portion of the top wall. A face opening 34 is formed in the inclined wall of the case 11. The face opening 34 communicates with a face outlet arranged at a top portion of the instrument panel through a face duct (not shown) for producing flow of the air (cooled air) toward an upper body of a front seat passenger through the face outlet.

In the case 11, a face door 35 is arranged below the face opening 34 to open and close the face opening 34. The face door 35 is an elongated rectangular panel door. The face door 35 is connected to a driving shaft 48 that is arranged at a rear end position within the inclined wall portion. The face door 35 is rotatable about the driving shaft 48.

The driving shaft 48 is rotatably supported by the case 11. One end of the driving shaft 48 projects to the outside of the case 11 and connects to an actuator 88 (FIG. 2) through a link system (not shown). The opening/closing position of the face door 35 is controlled by the actuator 88.

The top wall of the case 11 forms an instrument panel opening 36 at a position obliquely above the inclined wall forming the face opening 34 in the front direction. The instrument panel opening 36 communicates with an instrument panel outlet 55 and a ceiling outlet 56 through an instrument panel duct 200 as shown in FIG. 3. The air, which is conditioned in the air mixture area 19a, passes through the instrument panel opening 36 and flows to the outlets 55, 56 through the instrument panel duct 200. In FIG. 3, an exemplary arrangement of the instrument panel duct 200 is illustrated by a broken line. Although not illustrated, the ducts respectively connecting the openings 22, 30, 31, 34, 39 to the outlets 50, 51, 52, 53, 54 are provided at respective positions of the vehicle in a manner similar to the instrument panel duct 200.

The instrument panel duct 200 is branched into an instrument panel duct portion 200a and a ceiling duct portion 200b. Further, the instrument panel duct portion 200a and the ceiling duct portion 200b are branched into left portions and right portions, respectively. At the branched point between the instrument panel duct portion 200a and the ceiling duct portion 200b, an air-distributing door (not shown) is provided. The air-distributing door allows the air to flow to the ceiling outlet 56 and the instrument panel outlet 55 when opened, and allows the air to flow solely to the instrument panel outlet 55 when closed.

The instrument panel outlet 55 is constructed such that the air is blown from an entire area of the instrument panel outlet 55 toward the space between the vicinity of the passenger's upper body and the inside surface of the windshield. The ceiling outlet 56 is constructed such that the air is blown from an entire area of the ceiling outlet 56 toward the vicinity of the passenger's head and toward the inside surface of the windshield.

Below the instrument panel opening 36 in the case 11, an instrument panel door 37 is provided such that it opens and closes the instrument panel opening 36. The instrument panel door 37 is an elongated rectangular-shaped panel door extending in the left and right direction of vehicle. The instrument panel door 37 connects to a driving shaft 38. The driving shaft 38 is arranged adjacent to a front position of the instrument panel opening 36 in the inside of the case 11. Thus, the instrument panel door 37 is rotatable about the driving shaft 38.

The driving shaft 38 is rotatably supported in the case 11. One end of the driving shaft 38 projects to the outside of the case 11 to connect to an actuator 89 (FIG. 2) through a link system (not shown). The opening/closing position of the instrument panel door 37 is controlled by the actuator 89.

A front left door trim opening 39 is formed on the left side wall of the case 11. The front left door trim opening 39 is located at a position overlapping the air mixture area 19a, as shown in FIG. 1. The front left door trim opening 39 has a substantially fan shape. The front left door trim opening 39 is arranged such that the center of the fan shape is on its lower side. With this arrangement, the aperture area of the front left door trim opening 39 enlarges toward its upper side from its lower side. Similarly, a front right door trim opening (not shown), which has the shape same as the front left door trim opening 39, is formed on the right side wall of the case 11.

To open and close the fan-shaped front left door trim opening 39, a front left seat door trim door 40 is rotatably supported by a seventh left driving shaft 41. The front left seat door trim door 40 has a substantially fan shape. The seventh left driving shaft 41 is arranged to extend in the right and left direction. Both ends of the seventh left driving shaft 41 are rotatably supported by the case 11. Similarly, a front right seat door trim door, which has the same structure as the front left seat door trim door 41, is provided symmetrically on the right side of the separation wall in the case 11.

The front left door trim door 40 is arranged in the vicinity of the end of the seventh left driving shaft 41 such that it extends along an inside surface of the left side wall of the case 11. The front left door trim door 40 is so constructed as to open and close the front left door trim opening 39 by moving along the inside surface of the left side wall of the case 11. The front left door trim door 40 and the seventh left driving shaft 41 is for example integrally molded with resin.

The front left door trim opening 39 connects to a front left door trim duct (not shown). The front right door trim opening connects to a front right door trim duct (not shown).

The front left door trim duct connects to a front left door trim outlet (not shown). The front right door trim duct connects to a front right door trim outlet 57.

The seventh left driving shaft 41 is rotatably supported by the case 11. One end of the seventh left driving shaft 41 projects to the outside of the case 11 and connects to an actuator 90 (FIG. 2) through a link system (not shown). The opening/closing position of the front left door trim door 40 is controlled by the actuator 90.

A left cooled air bypass door 43 is provided above the evaporator 12 in the case 11. The left cooled air bypass door 43 is integrally connected to and rotatably supported by an eighth left driving shaft on the left side wall of the case 11. The left cooled air bypass door 43 is a rectangular shaped panel door. A cooled air passage 44a is formed when the left cooled air bypass door 43 opens. A right cooled air bypass door (not shown), which has the same structure as the left cooled air bypass door 43, is symmetrically provided on the right side of the separation wall in the case 11.

The eighth left driving shaft 42 is rotatably supported by the case 11. One end of the left eighth driving shaft 42 projects to the outside of the case 11 and connects to an actuator 91 (FIG. 2) through a link system (not shown). The opening/closing position of the left cooled air bypass door 43 is controlled by the actuator 91.

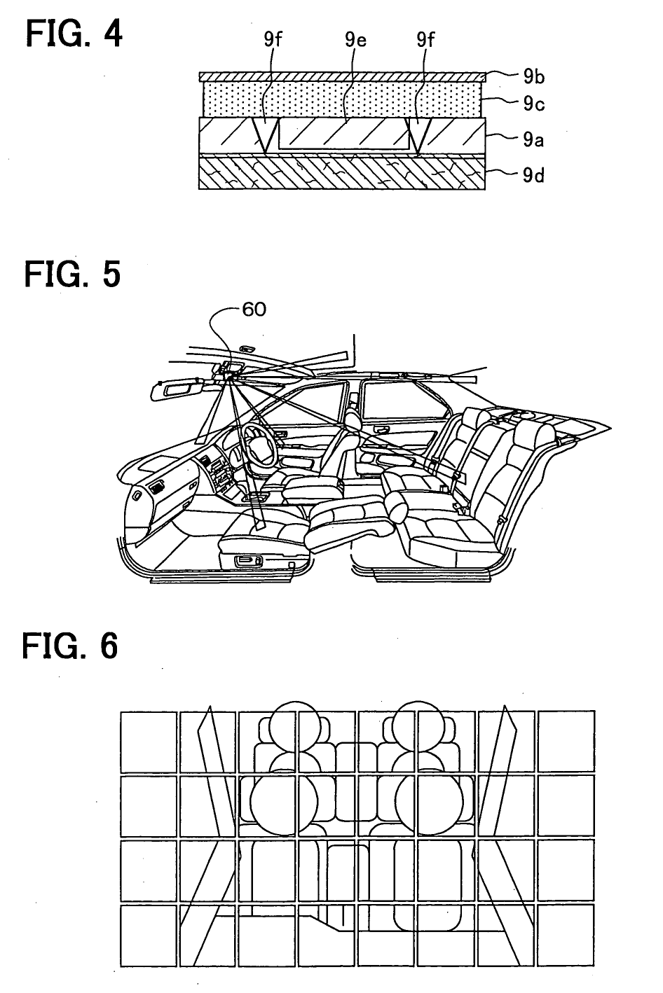

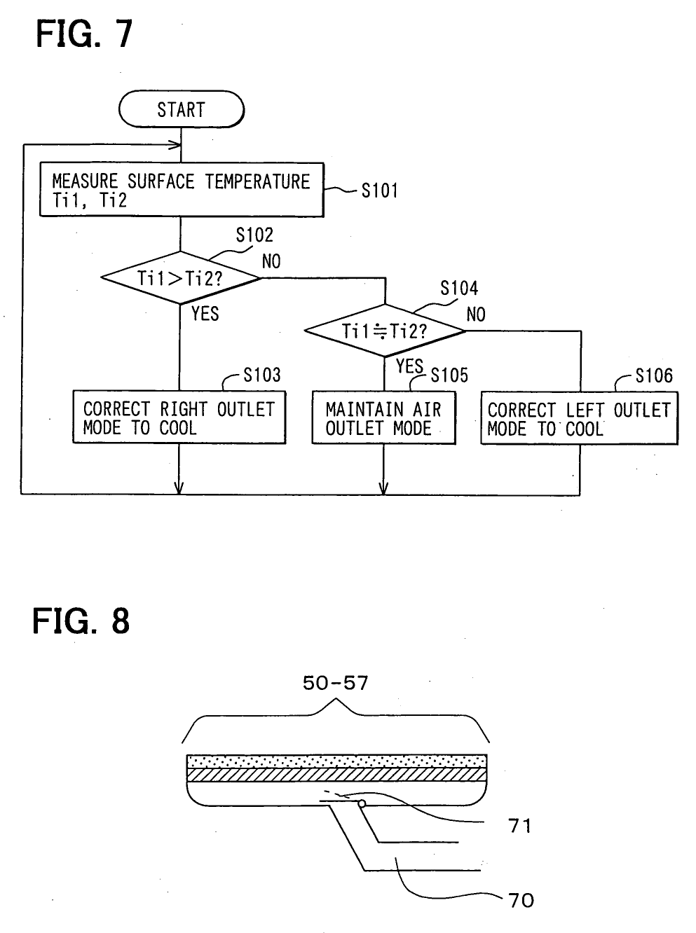

As shown in FIG. 4, the material forming the interior walls of the compartment, which include vehicle doors, has a multi-layered structure. The outlet portions 50 to 57, which are denoted by shaded-area in FIG. 3, are provided by the interior walls. The laminate structure includes a 3D net 9a having a three dimensional air channel (vent hole) 9e. By this, the air flows into the compartment from the wall outlet portion 50 to 57 such that the air exudes from the interior walls.

Incidentally, the multi-layered structure of the interior wall material includes sequentially from an outside to an inside a metal body layer 9b, a thermal insulation layer 9c made from resin such as polyester and polyurethane, the 3D net 9a, and a designed skin (surface layer) 9d. The thermal insulation layer 9c has imperviousness. For the designed skin 9d, an electrostatic fabric backing cloth is used so that a filter for eliminating dust and particles is formed on an outer surface of the designed skin 9d.

For example, the air channel 9e is formed by a pair of walls 9f that are formed by partly melting the 3D net 9a by welding. The air channel 9e between the walls 9f constructs a part of the duct (e.g. ceiling duct portion 200b in FIG. 3).

Next, the control system of the first embodiment will be described with reference to FIG. 2. An ECU 80 is a controller means composed of a microcomputer and its peripheral circuitry. The ECU 80 performs operation on the input signals based on a predetermined program and controls the operation such as driving signal outputting to the actuators and signal outputting to the blower driving circuit.

A plurality of sensors 81 is connected to the ECU 80 as input terminals. The sensors 81 detect any necessary information for air-conditioning control. In addition, a temperature setting device 82 is connected to the ECU 80. The temperature setting device 82 allows the passenger to adjust presetting temperature and volume of air at desired levels. As the sensors, for example, an outside air temperature sensor, an inside air temperature sensor, a solar radiation sensor, a coolant temperature sensor and an IR sensor are included. The temperature setting device 82 for example includes a front right seat switch, a front left seat switch, a rear right seat switch and a rear left seat switch.

The output terminals of the ECU 80 respectively connect to the actuators 83 to 91 for opening and closing the respective openings of the case 11, the blower driving circuit 92 for a blower motor of the main blower, and a blower driving circuit 93 of the blower motor 25.

Next, operation of the embodiment will be described.

When an ignition switch (not shown) is turned on, power is supplied to the ECU 80. Then, the command signals such as the preset temperature and the preset volume of air of the respective switches of the temperature setting device 82 are sent to the ECU 80. The switches of the temperature setting unit 82 are respectively arranged adjacent to the front right seat, the front left seat, the rear right seat, and the rear left seat in the compartment.

In addition, sensor signals of the sensors 81 for the air-conditioning are sent to the ECU 80. The ECU 80 computes a target temperature TAO of the air to be blown into the compartment based on the signals. The ECU determines the airflow volume of the main blower based on the target temperature TAO. Further, the ECU 80 sends signals to the blower driving circuit 92, so the voltage applied to the terminal of the blower motor terminal from the blower driving circuit 92 is controlled. Then the ECU 80 determines the opening positions (rates) of the left air mix doors 16, 21, 27, 29, and right air mix doors, which provide the first to sixth temperature control means, based on the target temperature TAO. Based on the determined opening rates, the doors are adjusted by the left actuators 83 to 86 and the right actuators (not shown), respectively.

The airflow volume from each opening is determined by the opening rate of the door of each opening. Thus, the airflow volume from each wall of the compartment is determined by the door opening rate.

Next, effects of the above-described arrangement will be described.

The opening area of the instrument panel opening 36 is varied by adjusting the opening rate of the instrument panel door 37. By this, the volume of air to be sent to the instrument panel and the ceiling are adjusted.

Similarly, the opening rates of the front left door trim door 40, the front right door trim door, the rear right air-distributing door, the rear left air-distributing door 33, the front right seat air mix door, and the front left seat air mix door 21 are independently adjusted. Therefore, the volume of air flow of each opening is independently controlled, and therefore the airflow volume of the corresponding outlet portion, which communicates with the opening through the duct (not shown), is independently controlled.

When the cooled air passage 15b is widened by enlarging the opening sectional area of the cooled air film 46 and the heated air passage 18a is narrowed by reducing the opening sectional area of the heated air film 47, the temperature of the air to be blown from the instrument panel outlet 55, the ceiling outlet 56, the front left door trim outlet, and the front right door trim outlet 57 toward the passenger is decreased. On the contrary, when the cooled air passage 15b is narrowed and the heated air passage 18a is widened, the temperature of the air to be blown from the instrument panel outlet 55, the ceiling outlet 56, the front left door trim outlet, and the front right door trim outlet 57 toward the passenger is increased. In addition, opening the passenger cooled air bypass door 43 allows the temperature of air to be blown from the above each outlets to be decreased.

Further, the air mixture ratio of the cooled air passage 15c to the heated air passage 18d is changed by rotating the front left seat air mix door 21 and the front right seat air mix door. By this, the temperature of air blowing from the front left seat outlet 50 and the front right seat outlet 51 to the passenger is changed.

Further, the air mixture ratio between the cooled air passage 15d and the heated air passage 18c is changed by rotating the rear left heated air mix door 27 and the rear left cooled air mix door 29. Similarly, the air mixture ratio between the cooled air passage 15d and heated air passage 18c of the right part is changed by rotating the rear right heated air mix door and the rear right cooled air mix door. Accordingly, the temperature of the air blowing from the rear right seat outlet 54, the rear left seat outlet 52, the rear right door trim outlet 53, and the rear left door trim outlet is changed.

Furthermore, the air-conditioned air from the air conditioner unit 10 is supplied such that it steeps and exudes the compartment walls. Therefore, the temperature of the interior walls is independently controlled. Because the wall temperature is independently controlled to be close to the skin temperature of the passenger, the effect of irradiation from the interior walls to the passengers is suppressed.

Further, when compared to the conventional thermal sensing auxiliary device, there is no need to convert electric power to heat, contributing to some power saving.

The features of the first embodiment will be summarized as follows.

The left air mix door 16, which is provided between the cooling heat exchanger 12 and the heating heat exchanger 13, functions as the first temperature control means that controls the temperature of the air to be supplied to the left region of the compartment by adjusting the volumes of the cooled air of the cooled air passages 15a, 15b and the air passing through the heating heat exchanger 13. The right air mix door, which has the structure same as the left air mix door 16 and is provided in the right part of the case 11, functions as the second temperature control means.

The heated air passage 18a merges with the cooled air passages 15a, 15b above the heating heat exchanger 13, thereby forming the air mixture area 19a. The air mixed at the air mixture area 19a flows through the instrument panel opening 36. From the instrument panel opening 36, the air is introduced to the instrument panel outlet 55 and the ceiling outlet 56 through the instrument panel duct 200.

When the cooled air passage 15b is widened by enlarging the opening area of the cooled air film 46 and the heated air passage 18a is narrowed by decreasing the opening area of the heated air film 47, the temperature of the air supplied to the compartment from the instrument panel outlet 55, the ceiling outlet 56, the front left door trim outlet through the instrument panel opening 36 is decreased. On the contrary, when the cooled air passage 15b is narrowed and the heated air passage 18a is widened, the air supplied to the compartment from the instrument panel outlet 55 and the ceiling outlet 56 is increased.

The front left seat air mix door 21 and the front right seat air mix door, which are provided below the heating heat exchanger 13, respectively function as the third temperature control means and the fourth temperature control means. The third and fourth temperature control means control the temperature of the air to be supplied to the compartment by adjusting the volumes of the cooled air of the cooled air passage 15c and the heated air having passed through the heating heat exchanger 13.

The heated air passage 18d merges with the cooled air passage 15c below the heating heat exchanger 13 at the air mixture area 19b. The front left seat opening 22 through which the mixed air is introduced to the front left seat outlet 50 is formed proximate to the air mixture area 19b in the left part of the case 11. Similarly, the front right seat opening is formed in the right part of the case 11.

The rear left seat auxiliary blower 23 is provided downstream of the heating heat exchanger 13 for blowing the air toward the rear left region of the compartment. The rear left seat heated air mix door 27 is rotatably supported upstream of the rear left seat auxiliary blower 23 for providing the heated air passage. Similar to the rear left seat heated air mix door 27 in the left part of the case 11, the rear right seat heated air mix door is provided in the right part of the case 11.

The rear left seat cooled air mix door 29 is rotatably supported for providing the cooled air passage. Under the rear left seat auxiliary blower 23, that is, upstream of the rear left seat auxiliary blower 23 in the left part of the case 11. Similar to the rear left seat cooled air mix door 29, the rear right seat cooled air mix door is provided in the right part of the case 11.

The rear left seat heated air mix door 27 and the rear left seat cooled air mix door 29 function as the fifth temperature control means for controlling the temperature of the air to be supplied to the rear left region of the compartment by adjusting the volumes of the cooled air of the cooled air passage 15d and the heated air of the heated air passage 18c. The rear right seat heated air mix door and the rear right seat cooled air mix door function as the sixth temperature control means for controlling the temperature of the air to be supplied to the rear right region of the compartment in the manner similar to the fifth temperature control means.

The heated air passage 18c merges with the cooled air passage 15d at the air mixture area 19c. The air mixture area 19c is proximate to the axial air inlet portion of the fan 24.

The rear right seat door trim opening 30 and the rear left seat opening 31 are formed downstream of the rear left seat auxiliary blower 23 in the left part of the case 11. Similarly, the rear left seat door trim opening and the rear right seat opening are formed downstream of the rear right seat auxiliary blower in the right part of the case 11.

The rear left seat air-distributing door 33 is rotatably supported at a position upstream of the rear left seat door trim opening 30 and the rear left seat opening 31. Similarly, the rear right seat air-distributing door is rotatably supported at a position upstream of the rear right seat door trim opening and the rear right seat opening.

The rear left set door trim opening 30 communicates with the rear left seat door trim outlet through the duct. The rear left seat opening 31 communicates with the rear left seat outlet 52 through the duct. Similarly, the rear right seat door trim opening communicates with the rear right seat door trim outlet 53 through the duct and the rear right seat opening communicates with the rear right seat outlet 54 through the duct.

The front left seat door trim opening 39 is arranged proximate to the air mixture area 19a on the side wall of the left part of the case 11. Similarly, the front right seat door trim opening is arranged proximate to the air mixture area 19a on the side wall of the right part of the case 11.

The front left seat door trim opening 39 and the front right seat door trim opening are opened and closed by the front left seat door trim door 40 and the front right seat door trim door, respectively. The front left seat door trim opening 39 communicates with the front left seat door trim opening through the front left seat door trim duct. The front right seat door trim opening communicates with the front right seat door trim opening 57 through the front right seat door trim duct.

[Second Embodiment]

In the second embodiment, an IR (infrared) sensor 60 is used in the air-conditioning system of the same arrangement as the first embodiment. The IR sensor 60 is arranged in the compartment, as shown in FIG. 5. The IR sensor 60 sends signals to the ECU 80, so the ECU 80 provides the control based on the signals.

As shown in FIG. 6, the IR sensor 60 has plural infrared detector elements that are arranged in a matrix form to detect the temperature distributions of predetermined detecting areas of the compartment. The IR sensor 60 is preferably arranged in the vicinity of the rear view mirror, which is located above the windshield, in the compartment.

As one preferred example, the ECU 80 may control to approximate some part of high thermal load to that of low thermal load based on the temperature distribution in the compartment detected by the IR sensor 60.

Specifically, if the temperature of at least one wall surface is higher than a predetermined temperature (e.g. about 40° C.) among the temperatures of plural wall surfaces of the compartment, it is determined that there is a high thermal load area for a cooling operation in the compartment. In this case, the ECU 80 controls so that the airflow volume of the wall outlet that is in the vicinity of the high temperature area is higher than that of the wall outlet that is in the vicinity of the low temperature area. Alternatively, the ECU 80 controls so that the temperature of the air flowing from the wall outlet that is in the vicinity of the high temperature area lower than that of the air flowing from the wall outlet that is in the vicinity of the low surface temperature area.

FIG. 8 shows the flow chart of the above control. At step 101, the temperature of the wall surfaces is detected. For example, Ti1 is a temperature of one of the wall surfaces of the right region of the compartment. Ti2 is a temperature of one of the wall surfaces of the left region of the compartment. At step 120, if it is determined that the temperature Ti1 is higher than the temperature Ti2, an air mode of the air outlet in the right region is corrected to the cool side at step 103. If it is determined that the temperature Ti1 is smaller than the temperature Ti2 at step 102, the control continues to step 104. At step 104, if it is determined that the temperature Ti1 is approximately equal to the temperature Ti2, the air outlet mode is maintained at step 105. If it is determined that the temperature Ti2 is higher than the temperature Ti1 at step 104, an air mode of the air outlet in the left region is corrected to the cool side at step 106.

On the contrary, if the temperature of at least one wall surface is lower than a predetermined temperature (e.g. about 15° C.) among the temperatures of plural wall surfaces of the compartment, it is determined that there is a high thermal load area for a heating operation in the compartment. In this case, the ECU 80 controls so that the airflow volume of the wall outlet that is in the vicinity of the low temperature area is higher than that of the wall outlet that is in the vicinity of the high temperature area. Alternatively, the ECU 80 controls so that the temperature of the air flowing from the wall outlet that is in the vicinity of the low temperature area higher than that of the air flowing from the wall outlet that is in the vicinity of the high surface temperature area.

Thus controlling enables the effect of irradiation from the wall surface to be equalized. This contributes to dull the passenger's thermal sensations caused by the irradiation from the compartment walls, resulting in a suppression of passenger's discomfort.

[Third Embodiment]

In the third preferred embodiment, one-way valves (check valves) 71 are provided at the ends of the ducts 70 in the vicinity of the wall outlets 50 to 57, as shown in FIG. 8. The one-way valves 71 restricts the air in the compartment from flowing back into the wall outlets 50 to 57. Since the reverse airflow is restricted by the one-way valves 71, the deposition of dust and particulates suspended in the air to the wall outlets is reduced. Accordingly, the blur of walls due to the deposited dust is suppressed.

The reverse airflow from the compartment into the wall outlets 50 to 57 is caused by the reason where the high pressure air in the compartment flows into the duct of low air pressure when the air pressure in the compartment is increased. This is caused for example at the moment that the door of the vehicle is closed.

In the embodiments, a whole given area of the wall in the compartment are used as the outlet. Thus, the wall outlets 50 to 57 of the first to third embodiments are so constructed as to differ from conventional air outlets of spot type from which air is blown out into the compartment.

The wall outlets 50 to 57 also permits of blowing air so as to be steeped into the compartment from a given area of surface, allowing directly interchanging heats between the surface of the compartment and the airflow of the wall outlets 50 to 57. This enables a quick suppression of wall heat irradiation than that by the conventional outlets. In addition, the outlet surface area of the wall outlets 50 to 57 is larger than that of the conventional outlets. Thus, the air-conditioned air is restricted from concentrically flowing against a part of the passenger body, leading to a suppression of cumbersome air-conditioned wind.

[Other Embodiments]

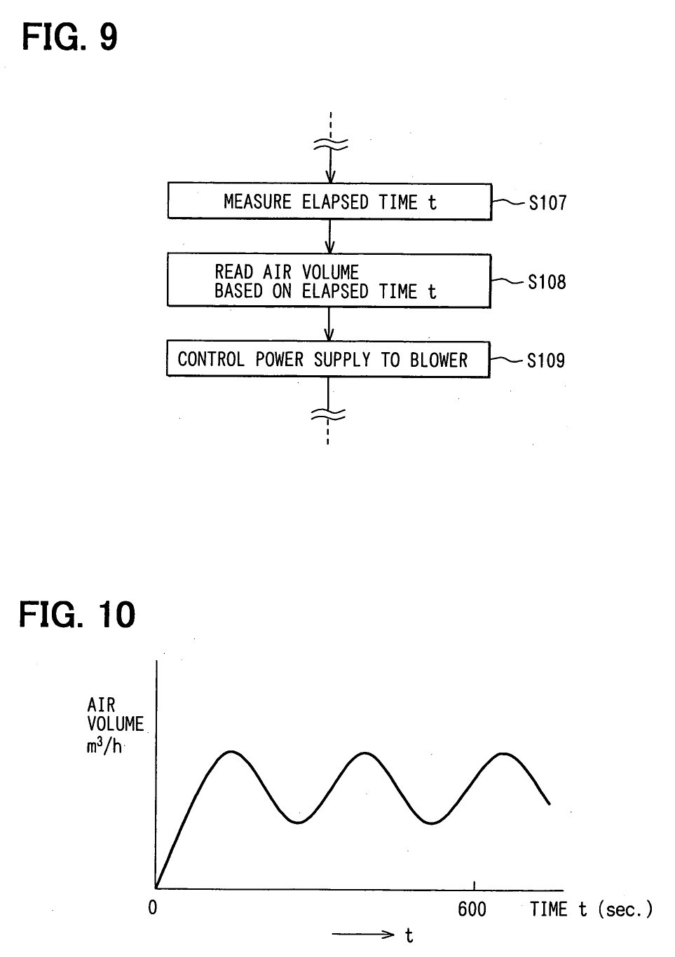

Regarding the plural wall outlets 50 to 57 described in the first embodiment, the air blown out to the passenger from the wall outlets 50 to 57 may optionally be changed so as to be switched from each other at predetermined intervals. Alternatively, the airflow volume of the wall outlets 50 to 57 may be altered at predetermined intervals. This preferably needs a control effected by applying steps 107 to 109 shown in FIG. 9 and using a predetermined map, which is shown in FIG. 10, showing relation between an elapsed time t and an airflow volume of the blower. Here, the term of “the predetermined intervals” includes “constant intervals” and “randomly”.

Incidentally, let us assume that airflow volume from the wall outlet (50 to 57) is fixed to a constant level. When a large volume of the airflow is continuously blown toward the passenger, the passenger may feel cumbersome. On the other hand, when the volume of the airflow is small, the passenger may be acclimatized to the air-conditioned atmosphere. As a result, the passenger may have less sensibility of being in the air-conditioned environment. To address this matter, by fluctuating the airflow from the outlet at the predetermined interval, even when the volume of the airflow from the outlet is large, the large volume of airflow is not continuously blown toward the passenger, so the passenger's cumbersome sensation may be suppressed. Similarly, even when the volume of the airflow of the outlet is small, the fluctuation of airflow volume will suppress the loss of sensation of being in the air-conditioned environment. Therefore the construction may provide more comfortable air-conditioned environment to the passengers.

The airflow volume to the wall outlets can be controlled by film doors, instead of the panel doors.

The wall outlets can be provided on the wall surfaces of front pillars (A-pillars), center pillars (B-pillars), and rear pillars (C-pillars) to blow air therefrom toward the passengers, in addition to the ceiling, the sheets, the instrument panel. Also, a duct for introducing the air to the A-pillar outlet and the door trim outlet can be shared.

The wall outlets can be provided on the wall surfaces above and below the meter panel so as to blow air from these outlets into the compartment, in addition to the ceiling, the sheets, the instrument panel.

Instead of the material of the interior walls having air permeability, a material having impermeability can be used for the material providing the wall outlets.

Instead of the one-way valves 71 provided in the proximity of the wall outlets 50 to 57, doors can be provided in the proximity of the wall outlets 50 to 57. The reverse flow of the air into the ducts 70 can be restricted by opening/closing the doors.

The present invention should not be limited to the disclosed embodiments, but may be implemented in other ways without departing from the spirit of the invention.

What is claimed is:

1. An air conditioner for air-conditioning a compartment of a vehicle comprising:
a heat exchanging unit for performing heat exchange between air to be blown into the compartment and a fluid that flows inside the heat exchanging unit;
a plurality of wall outlet portions provided on walls of the compartment for allowing the air passed through the heat exchanging unit to exude into the compartment; and
a plurality of control means for controlling at least one of temperature and volume of the air flowing through the wall outlet portions independently.

2. The air conditioner according to claim 1, wherein the heat exchanging unit includes a cooling heat exchanger for cooling air and a heating heat exchanger for heating air.

3. The air conditioner according to claim 2, wherein each of the control means includes an air mix door that controls the volume of air cooled by the cooling heat exchanger and the volume of air heated by the heating heat exchanger.

4. The air conditioner according to claim 1, wherein the wall of the compartment has a surface member having air permeability, and the wall outlet portions are provided by the surface member.

5. The air conditioner according to claim 1, wherein the wall is included in at least one of an instrument panel, a door trim, a ceiling, a portion above a meter, and a portion under the meter of the vehicle.

6. The air conditioner according to claim 1, wherein the volume of air flowing through at least one of the wall outlet portions is changed at predetermined intervals.

7. The air conditioner according to claim 1, wherein temperature of the walls is detected at plural positions, and the control means is controlled so that the temperature of the position where a heat load is high approximates to the temperature of the position where a heat load is low.

8. The air conditioner according to claim 1, further comprising:
a counter flow restricting means for restricting the air in the compartment from flowing back, wherein the counter flow restricting means is provided proximate to at least one of the wall outlet portions.

9. An air conditioner for air-conditioning a compartment of a vehicle, comprising:
a heat exchanger for performing heat exchange between a fluid flowing therein and air to be blown into the compartment;
a duct through which the air passed through the heat exchanger flows;
a plurality of wall outlet portions through which the air in the duct flows into the compartment, wherein the wall outlet portions are provided on a wall of the compartment;
a control means for controlling at least one of temperature and volume of the air; and
counter flow restricting means provided proximate to the wall outlet portions for restricting the air in the compartment from flowing back into the duct.

10. An air conditioner for air-conditioning a compartment of a vehicle, the air conditioner comprising:
an interior wall of the compartment forming a plurality of wall outlets through which air is blown into the compartment, wherein the wall outlets includes an instrument panel outlet, a ceiling outlet, a front right seat outlet, a rear right seat outlet, a front left seat outlet, a rear left seat outlet, a front right seat door trim outlet, a rear right seat door trim outlet, a front left seat door trim outlet, and a rear left seat door trim outlet; and
an air conditioner unit including
a cooling heat exchanger for cooling air,
a heating heat exchanger for heating air,
a case that houses the cooling heat exchanger and the heating heat exchanger therein, wherein the case is disposed such that its inside is separated into a first part and a second part, and the case forms
an instrument panel opening communicating with the instrument panel outlet and the ceiling outlet through an instrument panel duct,
a front right seat opening communicating with the front right seat outlet through a duct,
a rear right seat opening communicating with the rear right seat outlet through a duct,
a front left seat opening communicating with the front left seat outlet through a duct,
a rear left seat opening communicating the rear left seat outlet through a duct,
a front right seat door trim opening communicating with the front right seat door trim outlet through a duct,
a rear right seat door trim opening communicating with the rear right seat door trim outlet through a duct,
a front left seat door trim opening communicating with the front left seat door trim outlet through a duct, and
a rear left seat door trim opening communicating with the rear left seat door trim outlet through a duct, and
an instrument panel door disposed to change an opening area of the instrument panel opening for controlling the volume of air to be introduced to the instrument panel outlet and the ceiling outlet,
a rear left seat air-distributing door rotatably supported at a position upstream of the rear left seat door trim opening and the rear left seat opening,
a rear right seat air-distributing door rotatably supported at a position upstream of the rear right seat door trim opening and the rear right seat opening,
a front left seat door trim door disposed to open and close the front left seat door trim opening,
a front right seat door trim door disposed to open and close the front right seat door trim opening,
a front right seat air mix door for controlling the volume of air flowing through the front right seat opening by adjusting its opening rate, and
a front left seat air mix door for controlling the volume of air flowing through the front left seat opening by adjusting its opening rate.

11. The air conditioner according to claim 10, wherein the interior wall includes multi-layered structure forming three dimensional ventilation holes therein, thereby allowing the air to exude into the compartment.

12. The air conditioner according to claim 10, further comprising:
a first temperature control means for controlling the temperature of air to be blown into a left region of the compartment by adjusting the volume of cooled air cooled by the cooling heat exchanger and the volume of air to be heated by the heating heat exchanger, wherein the first temperature control means is located between the cooling heat exchanger and the heating heat exchanger in the first part of the case; and
a second temperature control means for controlling the temperature of air to be blown into a right region of the compartment by adjusting the volume of cooled air cooled by the cooling heat exchanger and the volume of air to be heated by the heating heat exchanger, wherein the second temperature control means is located between the cooling heat exchanger and the heating heat exchanger in the second part of the case.

13. The air conditioner according to claim 12,
wherein the first temperature control means is constructed of a left air mix door and the second temperature control means is constructed of a right air mix door,
wherein the first part and the second part of the case are disposed such that heated air passage and cooled air passage are formed so that heated air, which is heated by the heating heat exchanger, flows toward the instrument panel opening and merges with the cooled air, which is cooled by the cooling heat exchanger, at a position proximate to the instrument panel opening.

14. The air conditioner according to claim 12, further comprising:
a third temperature control means for controlling the temperature of air flowing through the front left seat opening by adjusting the volume of cooled air cooled by the cooling heat exchanger and the volume of heated air heated by the heating heat exchanger in the first part of the case;
a fourth temperature control means for controlling the temperature of air flowing through the front right seat opening by adjusting the volume of cooled air, which is cooled by the cooling heat exchanger, and the volume of heated air, which is heated by the heating heat exchanger, in the second part of the case.

15. The air conditioner according to claim 14,
wherein the third temperature control means is constructed of a front left seat air mix door rotatably supported at a position downstream of the heating heat exchanger in the first part of the case, and the fourth temperature control means is constructed of a front right seat air mix door rotatably supported at a position downstream of the heating heat exchanger in the second part of the case,
wherein the first part and the second part of the case are disposed such that the heated air flows toward the front left seat opening and the front right seat opening and merges with the cooled air positions proximate to the front left seat opening and the front right seat opening, respectively.

16. The air conditioner according to claim 14, further comprising:
a rear left blower including a centrifugal fan for introducing air to a rear left region of the compartment, wherein the rear left blower is located downstream of the heating heat exchanger and upstream of the rear left seat door trim opening and the rear left seat opening in the first part of the case; and
a rear right blower including a centrifugal fan for introducing air to a rear right region of the compartment, wherein the rear right blower is located downstream of the heating heat exchanger and upstream of the rear right seat door trim opening and the rear right seat opening in the second part of the case.

17. The air conditioner according to claim 16, further comprising:
a fifth temperature control means including
a rear left seat heated air mix door that is rotatably supported at a position upstream of the rear left seat blower for forming a heated air passage through which the heated air flows toward the rear left seat blower, and
a rear left seat cooled air mix door that is rotatably supported at a position upstream of the rear left seat blower for forming a cooled air passage through which the cooled air flows toward the rear left seat blower; and
a sixth temperature control means including
a rear right seat heated air mix door that is rotatably supported at a position upstream of the rear right seat blower for forming a heated air passage through which the heated air flows toward the rear right seat blower, and
a rear right seat cooled air mix door that is rotatably supported at a position upstream of the rear right seat blower for forming a cooled air passage through which the cooled air flows toward the rear right seat blower,
wherein the first part and the second part of the case are disposed such that the heated air merges with the cooled air at air intake ports of the rear left seat blower and the rear right seat blower, respectively.
